(19) United States
(12) Patent Application Publication
(10) Pub. No.: US 2016/0137873 A1
(43) Pub. Date: May 19, 2016

(54) GLARE-FREE, MICROSTRUCTURED, AND SPECIALLY COATED FILM

(71) Applicant: COVESTRO DEUTSCHLAND AG, Leverkusen (DE)

(72) Inventors: Serguei KOSTROMINE, Swisttal-Buschhoven (DE); Joachim PETZOLDT, Monheim (DE); Carsten BENECKE, Weil Am Rhein (DE)

(21) Appl. No.: 14/897,717

(22) PCT Filed: Jun. 11, 2014
(86) PCT No.: PCT/EP2014/062058

§ 371 Date: Dec. 11, 2015

(30) Foreign Application Priority Data
Jun. 14, 2013 (EP) 13172189.6

(51) Int. Cl. C09D 133/12; C09D 4/06

(52) U.S. Cl. CPC C09D 133/12; C09D 4/06

(57) ABSTRACT

The present invention relates to a polymer film having an anti-glare surface and a coating on this surface, said coating being obtainable by coating with a coating composition comprising at least one thermoplastic polymer in a content of at least 30% by weight of the solids content of the coating composition; at least one UV-curable reactive diluent in a content of at least 30% by weight of the solids content of the coating composition; at least one photoinitiator in a content of ≧0.1 to ≦10 parts by weight of the solids content of the coating composition; and at least one organic solvent; where the coating has a layer thickness in the range of ≧2 μm and ≦20 μm and the solids content of the coating composition is in the range from ≧0 to ≦40% by weight, based on the total weight of the coating composition. Thus, an anti-glare film having excellent solvent resistance and good scratch resistance or pencil hardness is provided.

The present invention relates to an anti-glare coated polymer film and to a coating composition for coating an anti-glare polymer film. The present invention further relates to a product comprising the inventive anti-glare, coated film and to the use thereof as a high-transparency anti-glare front pane for displays, especially for displays of computer screens, televisions, display systems and mobile phones, and for non-shiny plastics parts, especially those in the electrics, electronics and motor vehicle interior trim sectors. The present invention also relates to a process for producing the anti-glare coated films.

An anti-glare surface is understood to mean an optical surface where specular reflection is reduced (Becker, M. E. and Neumeier, J., 70.4: Optical Characterization of Scattering Anti-Glare Layers, SID Symposium Digest of Technical Papers, SID, 2011, 42, 1038-1041). Typical applications of such surfaces are found in display technology, but also in the fields of architecture, furniture, etc. In this context, the anti-glare configuration of films is the subject of particular attention because of its wide range of use.

There exist various methods in the art for imparting anti-glare properties to the surface of a film, for example by means of roughened surfaces (Huckaby, D. K. P. & Caims, D. R., 36.2, Quantifying “Sparkle” of Anti-Glare Surfaces, SID Symposium Digest of Technical Papers, 2009, 40, 511-513), by means of micro- or nanoparticles embedded into the surface layer (Liu, B. T., Teng, Y. T., A novel method to control inner and outer haze of an anti-glare film by surface modification of light-scattering particles, Journal of Colloid and Interface Science, 2010, 350, 421-426) or by means of micro- or nanostructures embossed into the surface (Boerner, V., Abbott, S. Bläsi, B., Gombert, A., Hoβfeld, W., 7.3, Blackwell Publishing Ltd., 2003, 34, 68-71). A further method involves establishing the scattering function through a phase separation in the surface layer (Stefan Walheim, Erik Schäffer, Jürgen Mlynek, Ullrich Steiner, Nanophase-Separated Polymer Films as High-Performance Antireflection Coatings, Science, 1999, 283, 520-522).

A process widespread in the prior art for imparting anti-glare properties to a film surface involves embossing a microstructure into the film surface. Transparent films, which are particularly used for this purpose, consist, for example, of polycarbonate, as obtainable, inter alia, under the Makrofol® trade name from the manufacturer Bayer Material Science AG. Films of this kind are produced, for example, by extrusion, in which case the surface texturing of the film is created by embossing with specific rolls into the as yet incompletely cooled polycarbonate. Films of this kind are available, for example, under the Makrofol® 1-M and 1-4 names from the manufacturer Bayer Material Science AG. The surface obtained in this way is thus anti-glare, but is sensitive to many solvents and is additionally soft and prone to scratching.

A particular challenge is to realize a very substantially anti-glare surface with simultaneously high transparency of the film. A further particular challenge to the person skilled in the art is to impart not just anti-glare properties to the surface of a film, but also simultaneously to make it sufficiently scratch-resistant and water- and solvent-resistant. Furthermore, in the field of display technology, readability or legibility is an important criterion for usability of a film in this area. The fulfillment of this profile of demands, i.e. the provision of a transparent film having an anti-glare and scratch-resistant surface and a high level of water and solvent resistance, is difficult to achieve. There is therefore a particular need for films which fulfil this profile of demands.

It has been found that, surprisingly, such a profile of demands can be achieved when the following is used: A polymer film having an anti-glare surface and a coating on this surface, said coating being obtainable by coating with a coating composition comprising
(a) at least one thermoplastic polymer in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent;
   where the coating has a layer thickness in the range of ≧2 μm and ≦20 μm and the solids content of the coating composition is in the range from ≧0 to ≦40% by weight, based on the total weight of the coating composition.

The present invention therefore provides the following:

An anti-glare polymer film, comprising a polymer film having an anti-glare surface and a coating on this surface, said coating being obtainable by coating with a coating composition comprising
(a) at least one linear thermoplastic polymer in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent;
   where the coating has a layer thickness in the range of ≧2 μm and ≦20 μm and the solids content of the coating composition is in the range from ≧0 to ≦40% by weight, based on the total weight of the coating composition.

Preferably, it is possible to use films of thermoplastics such as polycarbonate, polyacrylate or poly(meth)acrylate, polysulphones, polyesters, thermoplastic polyurethane and polystyrene, and the copolymers and mixtures (blends) thereof. Suitable thermoplastics are, for example, polyacrylates, poly(meth)acrylates (e.g. PMMA; e.g. Plexiglas® from the manufacturer Röhm), cycloolefin copolymers (COC; e.g. Topas® from the manufacturer Ticona; Zenoex® from the manufacturer Nippon Zeon or Apel® from the manufacturer Japan Synthetic Rubber), Polysulfone (Ultrason® from BASF or Udel® from the manufacturer Solvay), polyesters, for example PET or PEN, polycarbonate (PC), polycarbonate/polyester blends, e.g. PC/PET, polycarbonate/polycyclohexylmethanol cyclohexanedicarboxylate (PCCD; Xylecs® from the manufacturer GE), polycarbonate/PBT and mixtures thereof.

Particularly advantageous films have been found to be those made from polycarbonates or copolycarbonates, because of their transparency and suitability for microstructuring for the purposes of an anti-glare configuration. Examples of polycarbonate films usable in a particularly advantageous manner for the present invention include the polycarbonate films supplied by Bayer MaterialScience AG which have a microstructured surface on one side and a shiny or smooth surface on the other side. Said films are available under the 1-M and 1-4 names, one side having high gloss (side 1) and the other side having different microstructuring (side M or side 4). Sides M or 4 arise through the embossing action of rolls of different roughness in the course of production of the films. They differ by the mean depth or roughness depth (Rz, DIN EN ISO 4287) of the embossed structure.

Preference is given to using polycarbonates or copolycarbonates. In a particularly preferred embodiment of the present invention, the polymer film comprises a polycarbonate film.

Suitable polycarbonates for the production of the inventive film are all the known polycarbonates. These are homopolycarbonates, copolycarbonates and thermoplastic polyester carbonates. The suitable polycarbonates preferably have mean molecular weights M̅_{w} of 18 000 to 40 000, preferably of 26 000 to 36 000 and especially of 28 000 to 35 000, determined by measuring the relative solution viscosity in dichloromethane or in mixtures of equal weights of phenol/o-dichlorobenzene, calibrated by light scattering.

The polycarbonates are preferably prepared by the interfacial process or the melt transesterification process, which have been described many times in the literature. With regard to the interfacial process, reference is made by way of example to H. Schnell, Chemistry and Physics of Polycarbonates, Polymer Reviews, vol. 9, Interscience Publishers, New York 1964 p. 33 ff., to Polymer Reviews, vol. 10, “Condensation Polymers by Interfacial and Solution Methods”, Paul W. Morgan, Interscience Publishers, New York 1965, ch. VIII, p. 325, to Drs. U. Grigo, K. Kircher and P. R-Miller “Polycarbonate” [Polycarbonates] in Becker/Braun, Kunststoff-Handbuch [Polymer Handbook], volume 3/1, Polycarbonate, Polyacetale, Polyester, Celluloseester [Polycarbonates, Polyacetals, Polyesters, Cellulose Esters], Carl Hanser Publishers, Munich, Vienna, 1992, p. 118-145, and to EP-A 0 517 044. The melt transesterification process is described, for example, in the Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and U.S. Pat. No. 6,228,973.

The polycarbonates can be obtained from reactions of bisphenol compounds with carbonic acid compounds, especially phosgene, or diphenyl carbonate or dimethyl carbonate in the melt transesterification process. Particular preference is given here to homopolycarbonates based on bisphenol A and copolycarbonates based on monomers bisphenol A and 1,1-bis(4-hydroxyphenyl)-3,3,5-trimethylcyclohexane. Further bisphenol compounds which can be used for the polycarbonate synthesis are disclosed, inter alia, in WO-A-2008037364, EP-A-1 582 549, WO-A-2002/026862 and WO-A-2005/113639.

The polycarbonates may be linear or branched. It is also possible to use mixtures of branched and unbranched polycarbonates.

Suitable branching agents for polycarbonates are known from the literature and are described, for example, in patent specifications U.S. Pat. No. 4,185,009, DE-A 25 00 092, DE-A 42 40 313, DE-A 19 943 642, U.S. Pat. No. 5,367,044 and in literature cited therein. Furthermore, the polycarbonates used may also be intrinsically branched, in which case no branching agent is added in the course of polycarbonate preparation. One example of intrinsic branches is that of so-called Fries structures, as disclosed for melt polycarbonates in EP-A-1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

Optically at least partially anti-glare surfaces are understood to mean surfaces where specular reflection is distinctly reduced. Specular reflection is described by Snell's law, under which visible light which hits a non-absorbing, smooth surface at a particular angle (angle of incidence) is reflected at the same angle (angle of reflection). The two angles form the plane of incidence together with the perpendicular (theoretical normal to the surface). An anti-glare surface is achieved through suitable roughening of the surface. If light falls on a suitably roughened surface, the light is scattered in a diffuse manner in different directions. An anti-glare surface in the context of the present invention is understood to mean an optical interface where specular reflection is reduced, as described, for example, in Becker, M. E. and Neumeier, J., 70.4: Optical Characterization of Scattering Anti-Glare Layers, SID Symposium Digest of Technical Papers, SID, 2011, 42, 1038-1041. The anti-glare surface may preferably be roughened, as described, for example, in Huckaby, D. K. P. & Caims, D. R., 36.2, Quantifying “Sparkle” of Anti-Glare Surfaces, SID Symposium Digest of Technical Papers, 2009, 40, 511-513. It may preferably additionally or alternatively comprise micro- or nanoparticles embedded into the surface layer, as described, for example, in Liu, B. T., Teng, Y. T., A novel method to control inner and outer haze of an anti-glare film by surface modification of light-scattering particles, Journal of Colloid and Interface Science, 2010, 350, 421-426. Additionally or alternatively to the roughened surface or the surface comprising particles, anti-glare properties may be imparted to the at least one surface of the film according to the present invention by means of embossed micro- or nanostructures, as has been described, for example, in Boerner, V., Abbott, S, Bläsi, B., Gombert, A., Hoβfeld, W., 7.3, Blackwell Publishing Ltd., 2003, 34, 68-71. Additionally or alternatively, anti-glare properties can be achieved in the at least one surface according to the present invention by a phase separation in the surface, as has been described, for example, in Stefan Walheim, Erik Schäffer, Jürgen Mlynek, Ullrich Steiner, Nanophase-Separated Polymer Films as High-Performance Antireflection Coatings, Science, 1999, 283, 520-522. The content of the references cited and hence the disclosure thereof is hereby incorporated by reference.

Generally, the anti-glare configuration of the present invention more preferably comprises microstructuring of the surface of the film to be coated in accordance with the invention, and especially the microstructuring of the coated surface of the inventive film. A suitable definition of microstructuring in the context of the present invention is advantageously the term “roughness”, as used in DIN EN ISO 4287. According to DIN EN ISO 4287, the roughness of a surface is defined by the parameters Ra and Rz. Ra is the arithmetic mean of the absolute value of the profile deviations within the reference distance. Rz is the arithmetic mean of the greatest individual roughnesses from a plurality of adjacent individual measurement distances. Hereinafter, the parameter Rz, which can be determined in a reproducible manner to DIN EN ISO 4287, will be used to define the roughness and hence the microstructuring of the film surface.

The inventive concept is based on the roughness of the upper surface of the coating, which arises through the given roughness of the substrate to be coated. It has been found that an anti-glare configuration of the at least one surface of the inventive coated film can be achieved particularly advantageously when the at least one surface of the uncoated film has a roughness depth Rz to DIN EN ISO 4287 in the range of ≧500 and ≦4000 nm, preferably in the range of ≧700 and ≦3600 nm, more preferably in the range of ≧800 and ≦1500 nm, alternatively in the range of ≧2000 and ≦3800, preferably in the range of ≧2500 and ≦3600 nm.

For instance, the films of the Makrofol 1-M (Bayer) or Makrofol 1-4 (Bayer) type having anti-glare properties on one side, for use in a particularly advantageous manner in the context of the present invention, have a mean roughness depth Rz to DIN EN ISO 4287 in the range from 800 to 1300 nm, or in the range of 2800 to 3500 nm on the anti-glare side.

In a particularly preferred embodiment of the present invention, the microstructuring of the as yet uncoated, anti-glare, at least one film surface is characterized by a roughness depth Rz to DIN EN ISO 4287 in the range from ≧650 and ≦4000 nm, preferably in the range of ≧700 and ≦3600 nm, more preferably in the range of ≧800 and ≦1500 nm, alternatively in the range of ≧2000 and ≦3800, preferably ≧2500 and ≦3600 nm.

A particular challenge for the person skilled in the art was to coat the surface of a film to which anti-glare properties have been imparted in this way such that a certain scratch resistance and solvent resistance is firstly achieved, but anti-glare properties are maintained. It has been found that this aim can be achieved with a coating comprising a composition comprising at least one thermoplastic polymer in a content of at least 30% by weight of the solids content of the coating composition; at least one UV-curable reactive diluent in a content of at least 30% by weight of the solids content of the coating composition; at least one photoinitiator in a content of ≧0.1 to ≦10 parts by weight of the solids content of the coating composition; at least one organic solvent, where the coating has a layer thickness in the range of ≧2 μm and ≦20 μm and the solids content of the coating composition is in the range from ≧0 to ≦40% by weight, based on the total weight of the coating composition. The coating of the anti-glare side of the inventive film features good blocking resistance after the application to the film and subsequent drying, and a likewise good solvent resistance and high scratch resistance after curing by actinic radiation. The anti-glare properties of the anti-glare surface of the film are maintained when the inventive coating has a layer thickness in the range of ≧2 μm and ≦20 μm.

The coating composition for application in accordance with the invention is viscous; the viscosity rises very rapidly when the solvent disappears in the course of drying after application. Thus, the dried coating is immediately fixed on the microstructured surface. No migration, slip or flow from the heights to the depths of the microstructure is possible any longer. In spite of the high viscosity, the solids content of the coating composition is low, preferably in the range from ≧5% by weight to ≦40% by weight, more preferably ≧10% by weight to ≦30% by weight and most preferably ≧15% by weight to ≦25% by weight. In conjunction with the rapid rise in viscosity in the course of drying, this allows thin and relatively homogeneous coverage of the heights and depths of the microstructure of the anti-glare configuration of the film surface.

Generally, the microstructured, anti-glare surface of the film becomes smoother and clearer as a result of application of the inventive coating. The roughness of the resulting coating decreases with the effective layer thickness of the coating, such that the film, over and above a certain roughness value, no longer has an anti-glare appearance and instead has a shiny appearance.

There is no sharp boundary between anti-glare and shiny appearance according to the current prior art, either in terms of roughness values or in terms of other optical parameters. It is highly dependent on the production methods and applications. Two further optical parameters which could possibly define this boundary are the reflection level Rs (60° geometry) and haze.

An important, characteristic parameter for anti-glare films is the haze obtained from an optical scattering test method to ASTM-D1003. In this method, the scatter measured in transmission at a scatter angle greater than 2.5° is detected and normalized for the total intensity transmitted. The combination of reflection level and haze values gives rise to a plausible boundary for an anti-glare appearance of less than 70±10 GU (Rs) and more than 6±2% (haze). In a further preferred embodiment of the present invention, the gloss value of the coating to ASTM-D2457 at 60° is GU≦80.

The coated inventive films have anti-glare properties especially when they have a roughness Rz to DIN EN ISO 4287 of at least 600 nm after coating and curing of the coating. In this context, it will be appreciated that the Rz value of the coated film surface cannot be higher than the Rz of the corresponding uncoated anti-glare film surface. Proceeding from the case of the preferred films which, without the coating, preferably have a roughness depth Rz to DIN EN ISO 4287 in the range of ≧650 and ≦4000 nm, the inventive coated film surface also has a maximum roughness Rz within this range or within the abovementioned preferred ranges according to the present invention. In a particularly preferred embodiment of the present invention, the coated films have a roughness Rz to DIN EN ISO 4287 of at least 600 nm.

It has been found that an inventive coated film, over and above a coating thickness of 2 μm, compared to the uncoated film, has a distinct improvement in scratch resistance and resistance to solvents. Therefore, the layer thickness of the coating composition of the inventive films is preferably at least 2 μm and more preferably at least 4 μm. In the case of a layer thickness of the coating of more than 20 μm, in contrast, the roughness falls below the preferred values, and the film surfaces thus no longer have an anti-glare appearance and instead have a shiny appearance. Therefore, the layer thickness of the coating of the inventive films is preferably not higher than 20 μm. In a preferred embodiment, the coating is in a layer thickness in the range from ≧4 μm to ≦12 μm or in the range from ≧2 μm to ≦18 μm. Thus, especially a layer thickness of the inventive coating in the range from ≧4 μm to ≦12 μm is particularly advantageous on the anti-glare surface of a film having a roughness Rz in the range from 800 to 1300 nm, for example of the Makrofol 1-M type (Bayer). A layer thickness of the inventive coating in the range from ≧2 μm to ≦18 μm may especially be particularly advantageous on a surface of a film having a roughness Rz in the range from 2800 to 3500 nm, for example of the Makrofol 1-4 type (Bayer), in order to obtain an anti-glare and at the same time scratch-resistant and solvent-resistant surface.

Further optical parameters by which a use-relevant anti-glare film may be characterized are the distinctness of image (DOI; test method: ASTM-D5767) and the modulation transfer function (MTF). The latter is defined as the ratio of the contrast of the image and of the object. An additional option is an assessment via the sparkle effect (see Becker, M. E. & Neumeier, J.; 70.4: Optical Characterization of Scattering Anti-Glare Layers in SID Symposium Digest of Technical Papers, SID. 2011, 42, 1038-1041). According to the definition of the sparkle value (s=σ/μ; i.e. the ratio of variance (σ) to the mean (μ) of the intensity distribution of the display with anti-glare film), small values are the aim. For the DOI or MTF value, large values (→100%) are a development target.

In further preferred embodiments of the present invention, the coated films have DOI/MTF values of greater than 97%. Particularly preferred coated films according to the present invention thus have at least one coated surface having an Rz to DIN EN ISO 4287 of at least 600 nm and a gloss value to ASTM-D2457 at 60° of GU≦80, preferably in combination with DOI/MTF values of greater than 97%.

The coating of the at least one anti-glare surface of the inventive film is obtainable by coating with a coating composition comprising
(a) at least one thermoplastic polymer in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,
   where the solids content of the coating composition is in the range from ≧0 to ≦40% by weight, preferably in the range from ≧5% by weight to ≦40% by weight, more preferably ≧10% by weight to ≦30% by weight and most preferably ≧15% by weight to ≦25% by weight, based on the total weight of the coating composition. The coating composition thus forms a further part of the subject-matter of the present invention.

The Vicat softening temperatures VET (ISO 306) of the at least one thermoplastic polymer of the coating according to the present invention are, in a preferred embodiment of the present invention, in the region of at least 90° C., preferably at least 95° C., more preferably at least 100° C.

It has been found that the surface of the coating is particularly scratch-resistant and solvent-resistant especially when the at least one thermoplastic polymer has a mean molar mass Mw of at least 100 000 g/mol. In a preferred embodiment of the present invention, the thermoplastic polymer has a mean molar mass Mw of at least 100 000 g/mol, preferably of at least 150 000 g/mol, more preferably of at least 200 000 g/mol.

Thermoplastic polymers in the context of the present invention are especially polymethylmethacrylate (PMMA), various kinds of polyester (e.g. PET, PEN, PBTP and UP), other polymers such as rigid PVC, cellulose esters (such as CA, CAB, CP), polystyrene (PS) and copolymers (SAN, SB and MBS), polyacrylonitrile (PAN), ABS polymers, acrylonitrile-methyl methacrylate (AMMA), acrylonitrile-styrene-acrylic ester (ASA), polyurethane (PUR), polyethylene (PE, PE-HD, -LD, -LLD, -C), polypropylene (PP), polyamide (PA), polycarbonate (PC) or polyether sulphone (PES). The above abbreviations of the polymers and copolymers are defined in DIN 7728T1.

Particularly advantageous and therefore particularly preferred is polymethylmethacrylate.

Polymethylmethacrylate (PMMA) is understood to mean especially polymethylmethacrylate homopolymer and methyl methacrylate-based copolymers having a methyl methacrylate content of more than 70% by weight. Such polymethylmethacrylates are obtainable, for example, under the trade names Degalan®, Degacryl®, Plexyglas®, Acrylite® (manufacturer: Evonik), Altuglas, Oroglas (manufacturer: Arkema), Elvacite®, Colacryl®, Lucite® (manufacturer: Lucite), and under the names including Acrylglas, Conacryl, Deglas, Diakon, Friacryl, Hesaglas, Limacryl, PerClax and Vitroflex.

In a further advantageous embodiment, preference is given to PMMA homopolymers and/or copolymers of 70% by weight to 99.5% by weight of methyl methacrylate and 0.5% by weight to 30% by weight of methyl acrylate. Particular preference is given to PMMA homopolymers and copolymers of 90% by weight to 99.5% by weight of methyl methacrylate and 0.5% by weight to 30% by weight of methyl acrylate. The Vicat softening temperatures VET (ISO 306) of these preferred PMMA homopolymers and/or copolymers may be in the region of at least 90° C., preferably from ≧100° C. to ≦115° C.

Particular preference is given to PMMA homopolymers and copolymers having a molecular weight Mw of at least 100 000 g/mol, more preferably of at least 150 000 g/mol, very particularly of at least 200 000 g/mol.

The molecular weight Mw can be determined, for example, by gel permeation chromatography or by the scattered light method (see, for example, H. F. Mark et al., Encyclopedia of Polymer Science and Engineering, 2nd edition, vol. 10, pages 1 ff., J. Wiley, 1989).

The polymer is an essential part of the inventive coating composition and of the inventive coating. The proportion of the thermoplastic polymer in the solids content of the coating composition is at least 30% by weight. Particular preference is given to at least 40% by weight, very particular preference to at least 45% by weight.

Reactive diluents usable with preference as component (b) of the inventive coating composition are bifunctional, trifunctional, tetrafunctional, pentafunctional or hexafunctional acrylic and/or methacrylic monomers. Preference is given to ester functions, especially acrylic ester functions. Suitable polyfunctional acrylic acid or methacrylic esters derive from aliphatic polyhydroxyl compounds having at least 2, preferably at least 3 and more preferably at least 4 hydroxyl groups, and preferably 2 to 12 carbon atoms.

Examples of such aliphatic polyhydroxyl compounds are ethylene glycol, propylene glycol, butane-1,4-diol, hexane-1,6-diol, diethylene glycol, triethylene glycol, glycerol, trimethylolpropane, pentaerythritol, dipentaerythritol, tetramethylolethane and sorbitan. Examples of esters suitable with preference in accordance with the invention as reactive diluents are glycol diacrylate and dimethacrylate, butylene glycol diacrylate or dimethacrylate, dimethylolpropane diacrylate or dimethacrylate, diethylene glycol diacrylate or dimethacrylate, divinylbenzene, trimethylolpropane triacrylate or trimethacrylate, glyceryl triacrylate or trimethacrylate, pentaerythrityl tetraacrylate or tetramethacrylate, dipentaerythrityl penta-/hexaacrylate (DPHA), butane-1,2,3,4-tetraol tetraacrylate or tetramethacrylate, tetramethylolethane tetraacrylate or tetramethacrylate, 2,2-dihydroxypropane-1,3-diol tetraacrylate or tetramethacrylate, diurethane dimethacrylate (UDMA), sorbitan tetra-, penta- or hexaacrylate or the corresponding methacrylates. It is also possible to use additionally mixtures of crosslinking monomers having two to four or more ethylenically unsaturated, free-radically polymerizable groups.

Additionally in accordance with the invention, it is possible to use, as reactive diluents or components b) of the inventive coating composition, alkoxylated di-, tri-, tetra-, penta- and hexaacrylates or -methacrylates. Examples of alkoxylated diacrylates or -methacrylates are alkoxylated, preferably ethoxylated, methanediol diacrylate, methanediol dimethacrylate, glyceryl diacrylate, glyceryl dimethacrylate, neopentyl glycol diacrylate, neopentyl glycol dimethacrylate, 2-butyl-2-ethylpropane-1,3-diol diacrylate, 2-butyl-2-ethylpropane-1,3-diol dimethacrylate, trimethylolpropane diacrylate or trimethylolpropane dimethacrylate.

Examples of alkoxylated triacrylates or -methacrylates are alkoxylated, preferably ethoxylated, pentaerythrityl triacrylate, pentaerythrityl trimethacrylate, glyceryl triacrylate, glyceryl trimethacrylate, butane-1,2,4-triol triacrylate, butane-1,2,4-triol trimethacrylate, trimethylolpropane triacrylate, trimethylolpropane trimethacrylate, tricyclodecanedimethanol diacrylate, tricyclodecanedimethanol dimethacrylate, ditrimethylolpropane tetraacrylate or ditrimethylolpropane tetramethacrylate.

Examples of alkoxylated tetra-, penta- or hexaacrylates are alkoxylated, preferably ethoxylated, pentaerythrityl tetraacrylate, dipentaerythrityl tetraacrylate, dipentaerythrityl pentaacrylate, dipentaerythrityl hexaacrylate, pentaerythrityl tetramethacrylate, dipentaerythrityl tetramethacrylate, dipentaerythrityl pentamethacrylate or dipentaerythrityl hexamethacrylate.

In the alkoxylated diacrylates or -methacrylates, triacrylates or -methacrylates, tetraacrylates or -methacrylates, pentaacrylates or -methacrylates and/or alkoxylated hexaacrylates or -methacrylates in component b), all the acrylate groups or methacrylate groups or only some of the acrylate groups or methacrylate groups in the respective monomer may be bonded to the corresponding radical via alkylene oxide groups. It is also possible to use any desired mixtures of such wholly or partly alkoxylated di-, tri-, tetra-, penta- or hexaacrylates or -methacrylates. In this case, it is also possible that the acrylate or methacrylate group(s) is/are bonded to the aliphatic, cycloaliphatic or aromatic radical of the monomer via a plurality of successive alkylene oxide groups, preferably ethylene oxide groups. The mean number of alkylene oxide or ethylene oxide groups in the monomer is stated by the alkoxylation level or ethoxylation level. The alkoxylation level or ethoxylation level may preferably be from 2 to 25, particular preference being given to alkoxylation levels or ethoxylation levels of 2 to 15, most preferably of 3 to 9.

Likewise in accordance with the invention, reactive diluents or components b) of the inventive coating composition may be oligomers which belong to the class of the aliphatic urethane acrylates or of the polyester acrylates or polyacryloylacrylates. The use thereof as paint binders is known and is described in Chemistry & Technology of UV & EB Formulation for Coatings, Inks & Paints, vol. 2, 1991, SITA Technology, London (P. K. T. Oldring (ed.) on p. 73-123 (Urethane Acrylates) and p. 123-135 (Polyester Acrylates). Commercially available examples which are suitable within the inventive context include aliphatic urethane acrylates such as Ebecryl® 4858, Ebecryl® 284, Ebecryl® 265, Ebecryl® 264, Ebecryl® 8465, Ebecryl® 8402 (each manufactured by Cytec Surface Specialities), Craynor® 925 from Cray Valley, Viaktin® 6160 from Vianova Resin, Desmolux VP LS 2265 from Bayer MaterialScience AG, Photomer 6891 from Cognis, or else aliphatic urethane acrylates dissolved in reactive diluents, such as Laromer® 8987 (70% in hexanediol diacrylate) from BASF AG, Desmolux U 680 H (80% in hexanediol diacrylate) from Bayer MaterialScience AG, Craynor® 945B85 (85% in hexanediol diacrylate), Ebecryl® 294/25HD (75% in hexanediol diacrylate), Ebecryl® 8405 (80% in hexanediol diacrylate), Ebecryl® 4820 (65% in hexanediol diacrylate) (each manufactured by Cytec Surface Specialities) and Craynor® 963B80 (80% in hexanediol diacrylate), each from Cray Valley, or else polyester acrylates such as Ebecryl® 810, 830, or polyacryloylacrylates such as Ebecryl®, 740, 745, 767 or 1200 from Cytec Surface Specialities.

In a further preferred embodiment, the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaaacrylates and/or pentamethacrylates, alkoxylated hexaacrylates and/or hexamethacrylates, aliphatic urethane acrylates, polyester acrylates, polyacryloylacrylates and mixtures thereof.

Also in accordance with the invention are mixtures of such crosslinking multifunctional monomers and monofunctional monomers (for example methyl methacrylate). The proportion of the multifunctional monomers in such a mixture should not be below 20% by weight.

Component (b) is an essential part of the inventive coating composition and of the inventive coating. The total proportion of component (b) in the solids content of the coating composition is at least 30% by weight. Particular preference is given to at least 40% by weight, very particular preference to at least 45% by weight.

The content of ethylenically unsaturated groups has a significant influence on the achievable durability properties of the radiation-cured coating. Therefore, the inventive coating composition preferably contains a content of ethylenically unsaturated groups of at least 3.0 mol per kg of solids content of the coating composition, more preferably of at least 3.5 mol per kg, most preferably at least 4.0 mol per kg of solids content of the coating composition. This content of ethylenically unsaturated groups is also well known to the person skilled in the art by the term “double bond density”.

The photoinitiators of the present invention are understood to mean the standard, commercially available compounds, for example α-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacylphosphine oxide and others, said photoinitiators being utilizable alone or in combination of two or more or in combination with one of the above polymerization initiators.

UV photoinitiators used are, for example, the IRGACURE® products from BASF, for example the products IRGACURE® 184, IRGACURE® 500, IRGACURE® 1173, IRGACURE® 2959, IRGACURE® 745, IRGACURE® 651, IRGACURE® 369, IRGACURE® 907, IRGACURE® 1000, IRGACURE® 1300, IRGACURE® 819, IRGACURE® 819DW, IRGACURE® 2022, IRGACURE® 2100, IRGACURE® 784, IRGACURE® 250; in addition, the DAROCUR® products from BASF are used, for example the products DAROCUR® MBF, DAROCUR® 1173, DAROCUR® TPO, DAROCUR® 4265. Among other substances, the further UV photoinitiators are used, for example Esacure One (manufacturer: Lamberti).

Photoinitiators are present at ≧0.1 to ≦10 parts by weight in the solids content of the inventive coating composition.

The coating composition may additionally contain, over and above the solids content of the 100 parts by weight of components a) to c), one or more organic solvents. Such organic solvents may be selected, for example, from the group comprising aromatic solvents, for example xylene or toluene, ketones, for example acetone, 2-butanone, methyl isobutyl ketone, diacetone alcohol, alcohols, for example methanol, ethanol, i-propanol, butanol, l-methoxy-2-propanol, ethers, for example 1,4-dioxane, ethylene glycol n-propyl ether, or esters, for example ethyl acetate, butyl acetate, 1-methoxy-2-propyl acetate, or mixtures comprising these solvents.

Preference is given to ethanol, i-propanol, butanol, ethyl acetate, butyl acetate, 1-methoxy-2-propanol, diacetone alcohol, xylene or toluene, and mixtures thereof. Particular preference is given to i-propanol, butanol, ethyl acetate, butyl acetate, 1-methoxy-2-propanol, diacetone alcohol and mixtures thereof. Very particular preference is given to 1-methoxy-2-propanol and diacetone alcohol. Particular emphasis and hence preference is given here to 1-methoxy-2-propanol, since it advantageously behaves entirely neutrally with respect to polycarbonate and does not affect the mean roughness Rz of the anti-glare surface.

The coating composition of the present invention preferably contains, in addition to the solids content with the 100 parts by weight of components a) to c), 0 to 900 parts by weight, more preferably 100 to 850 parts by weight, most preferably 200 to 800 parts by weight, of at least one organic solvent.

In a very particularly preferred embodiment of the present invention, the inventive coated anti-glare film comprises a transparent polycarbonate film having microstructuring of the coated surface with an Rz in the range from ≧800 to ≦1300 nm or from ≧2800 to ≦3500 nm and a coating obtainable by coating with a coating composition comprising 45 to 50% by weight of at least one linear PMMA copolymer having a mean molar mass of at least 100 000 g/mol; 45 to 50% by weight of at least one reactive diluent, especially dipentaerythrityl penta-/hexaacrylate; 0.1 to 10 parts by weight of at least one photoinitiator, and 1-methoxy-2-propanol as an organic solvent, where the coating composition has a content of ethylenically unsaturated groups of 4.5 to 5.5 mol per kg of the solids content of the coating composition and a solids content in the range from 15 to 25% by weight, and the coating has a roughness Rz in the range ≧600 and ≦1300 nm, and the gloss value GU of the coated anti-glare surface to ASTM-D2457 at 60° is less than or equal to 80.

The coating composition according to the present invention may additionally optionally contain, over and above the 100 parts by weight of components a) to c), one or more further coatings additives. Such coatings additives may be selected, for example, from the group comprising stabilizers, levelling agents, surface additives, pigments, dyes, inorganic nanoparticles, adhesion promoters, UV absorbers, IR absorbers, preferably from the group comprising stabilizers, levelling agents, surface additives and inorganic nanoparticles. The coating composition of the present invention may comprise, in preferred embodiments, in addition to the 100 parts by weight of components a) to c), ≧0 to ≦35 parts by weight, more preferably ≧0 to ≦30 parts by weight, most preferably ≧0.1 to ≦20 parts by weight, of at least one further coatings additive. Preferably, the total proportion of all the coatings additives present in the coating material composition is ≧0 to ≦35 parts by weight, more preferably ≧0 to ≦30 parts by weight, most preferably ≧0.1 to ≦20 parts by weight.

The coating composition may comprise inorganic nanoparticles to increase the mechanical durability, for example scratch resistance and/or pencil hardness.

Useful nanoparticles include inorganic oxides, mixed oxides, hydroxides, sulphates, carbonates, carbides, borides and nitrides of elements of main group II to IV and/or elements of transition group I to VIII of the Periodic Table, including the lanthanides. Preferred nanoparticles are silicon oxide, aluminium oxide, cerium oxide, zirconium oxide, niobium oxide, zinc oxide or titanium oxide nanoparticles, particular preference being given to silicon oxide nanoparticles.

The particles used preferably have mean particle sizes (measured by means of dynamic light scattering in dispersion, determined as the Z-average) of less than 200 nm, preferably of 5 to 100 nm, more preferably 5 to 50 nm. Preferably at least 75%, more preferably at least 90%, even more preferably at least 95%, of all the nanoparticles used have the sizes defined above.

The coating composition can be produced in a simple manner by first of all dissolving the polymer completely in the solvent at room temperature or at elevated temperatures and then the other obligatory and any optional components to the solution which has been cooled to room temperature, either combining them in the absence of solvent(s) and mixing them together by stirring, or in the presence of solvent(s), for example adding them to the solvent(s), and mixing them together by stirring. Preferably, first the photoinitiator is dissolved in the solvent(s) and then the further components are added. This is optionally followed by a purification by means of filtration, preferably by means of fine filtration.

The present invention therefore further provides a process for producing a coated film, comprising the steps of
(i) providing a film having at least one anti-glare surface of the film;
(ii) coating the film on the side of the anti-glare surface with a coating composition comprising
   (a) at least one thermoplastic polymer in a content of at least 30% by weight of the solids content of the coating composition;
   (b) at least one UV-curable reactive diluent in a content of at least 30% by weight of the solids content of the coating composition;
   (c) at least one photoinitiator in a content of ≧0.1 to ≦10 parts by weight of the solids content of the coating composition; and
   (d) at least one organic solvent;
      where the coating has a layer thickness in the range of ≧2 μm and ≦20 μm and the solids content of the coating composition is in the range from ≧0 to ≦40% by weight, based on the total weight of the coating composition;
(iii) drying the coating;
(iv) optionally cutting the film to size and/or delaminating, printing and/or thermally or mechanically forming the film; and
(v) irradiating the coating with actinic radiation to cure the coating.

The film can be coated with the coating composition by the standard methods for coating films with fluid coating compositions, for example by knife-coating, spraying, pouring, flow-coating, dipping, rolling or spin-coating. The flow-coating process can be effected manually with a hose or suitable coating head, or automatically in a continuous run by means of flow-coating robots and optionally slot dies. Preference is given to the application of the coating composition by a roll-to-roll transfer. In this case, the surface of the film to be coated may be pretreated by cleaning or activation.

The drying follows the application of the coating composition to the substrate, preferably a film. For this purpose, more particularly, elevated temperatures in ovens, and moving and optionally also dried air, for example in convection ovens or by means of nozzle dryers, and thermal radiation such as IR and/or NIR, are employed. In addition, it is possible to use microwaves. It is possible and advantageous to combine a plurality of these drying processes. The drying of the coating in step (ii) preferably comprises flash-off at room temperature and/or elevated temperature, such as preferably at 20-200° C., more preferably at 40-120° C. After the coating has been dried, it is blocking-resistant, and so the coated film can be laminated, printed and/or thermally formed. Forming in particular is preferred in this context, since it is possible here to define the mould for a film insert moulding process for production of a three-dimensional plastics part.

Advantageously, the conditions for the drying are selected such that the elevated temperature and/or the thermal radiation does not trigger any polymerization (crosslinking) of the acrylate or methacrylate groups, since this can impair formability. In addition, the maximum temperature attained should appropriately be selected at a sufficiently low level that the film does not deform in an uncontrolled manner.

After the drying/curing step, the coated film, optionally after lamination with a protective film on the coating, can be rolled up. The film can be rolled up without the coating sticking to the reverse side of the substrate film or of the laminating film. However, it is also possible to cut the coated film to size and to send the cut sections individually or as a stack to further processing.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiative curing is preferably effected by the action of high-energy radiation, i.e. UV radiation or daylight, for example light of wavelength ≧200 nm to ≦750 nm, or by irradiation with high-energy electrons (electron beams, for example ≧90 keV to ≦300 keV). The radiation sources used for light or UV light are, for example, moderate- or high-pressure mercury vapour lamps, wherein the mercury vapour may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≧80 mJ/cm² to ≦5000 mJ/cm².

In a preferred embodiment, the actinic radiation is therefore light in the UV light range.

The radiation can optionally be performed with exclusion of oxygen, for example under inert gas atmosphere or reduced-oxygen atmosphere. Suitable inert gases are preferably nitrogen, carbon dioxide, noble gases or combustion gases. In addition, the radiation can be effected by covering the coating with media transparent to the radiation. Examples thereof are polymer films, glass or liquids such as water.

According to the radiation dose and curing conditions, the type and concentration of any initiator used can be varied or optimized in a manner known to those skilled in the art or by exploratory preliminary tests. For curing of the formed films, it is particularly advantageous to conduct the curing with several emitters, the arrangement of which should be selected such that every point on the coating receives substantially the optimal radiation dose and intensity for curing. More particularly, unirradiated regions (shadow zones) should be avoided.

In addition, according to the film used, it may be advantageous to select the irradiation conditions such that the thermal stress on the film does not become too great. In particular, thin films and films made from materials having a low glass transition temperature can have a tendency to uncontrolled deformation when a particular temperature is exceeded as a result of the irradiation. In these cases, it is advantageous to allow a minimum level of infrared radiation to act on the substrate, by means of suitable filters or a suitable design of the emitters. In addition, reduction of the corresponding radiation dose can counteract uncontrolled deformation. However, it should be noted that a particular dose and intensity in the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. In that case, photoinitiators are used in concentrations of ≧0.1% by weight to ≦10% by weight, more preferably of ≧0.2% by weight to ≦3.0% by weight, based on the solids content of the coating. These coatings are preferably cured using a dose of ≧80 mJ/cm² to ≦5000 mJ/cm².

The resulting cured, coated and optionally formed film shows very good resistances to solvents, staining liquids as occur in the household, and high hardness, good scratch and abrasion resistances, coupled with high optical transparency and anti-glare properties.

The film or else sheet is preferably used in a thickness of ≧10 μm to ≦1500 μm, more preferably of ≧50 μm to ≦1000 μm and especially preferably of ≧200 μm to ≦400 μm. In addition, the film material may comprise additives and/or processing aids for film production, for example stabilizers, light stabilizers, plasticizers, fillers such as fibres, and dyes.

In one embodiment, the film is a polycarbonate film having a thickness of ≧10 μm to ≦1500 μm. This likewise includes a polycarbonate film having the aforementioned additives and/or processing aids. The thickness of the film may also be ≧50 μm to ≦1000 μm or ≧200 μm to ≦400 μm.

The film may be coated on one or both sides, preference being given to single-sided coating. In the case of single-sided coating, a thermally formable adhesive layer may optionally be applied on the reverse side of the film, i.e. on the surface to which the coating composition is not applied. For this purpose, according to the procedure, preferably hotmelt adhesives or radiation-curing adhesives are suitable. In addition, it is also possible to apply a likewise thermally formable protective film on the surface of the adhesive layer. In addition, it is possible to provide the film with backing materials such as fabrics on the reverse side, but these should be formable to the desired degree.

On account of the excellent properties mentioned, the inventive coated film is suitable for use in products in many fields of industry, especially those in which an anti-glare or at least non-shiny surface having a high mechanical and chemical stability is required. The present invention therefore further provides a product comprising at least one transparent coated polymer film according to the present invention, the product being selected from the group consisting of architectural glazing elements such as, more particularly, diffusing partition screens as, for example, in bathrooms or greenhouses, covering panes, and front panes for displays. Equally preferred products are non-shiny plastics parts for electrics, electronics and motor vehicle interior trim. In a preferred embodiment of the present invention, this display is a display of computer screens, televisions, display systems and mobile phones. In a further preferred embodiment of the present invention, the product is an element of motor vehicle interior trim, for example a dashboard.

The present invention further provides for the use of the inventive anti-glare coated polymer film as a high-transparency anti-glare front pane for displays. In a preferred embodiment of the inventive use of the inventive coated film, the display is a display of computer screens, televisions, display systems and mobile phones.

### EXAMPLES

### Assessment Methods

The layer thickness of the coatings was measured by observing the cutting-edge in an Axioplan optical microscope manufactured by Zeiss. Method—reflected light, bright field, magnification 500×.

### Assessment of Pencil Hardness

The pencil hardness was measured analogously to ASTM D 3363 using an Elcometer 3086 Scratch boy (Elcometer Instruments GmbH, Aalen, Germany) under a load of 500 g unless stated otherwise.

### Assessment of Steel Wool Scratching

The steel wool scratching is determined by sticking a piece of No. 00 steel wool (Oskar Weil GmbH Rakso, Lahr, Germany) onto the flat end of a 500 g fitter's hammer, the area of the hammer being 2.5 cm×2.5 cm, i.e. approximately 6.25 cm². The hammer is placed onto the surface to be tested without applying additional pressure, such that a defined load of about 560 g is attained. The hammer is then moved back and forth 10 times in twin strokes. Subsequently, the stressed surface is cleaned with a soft cloth to remove fabric residues and coating particles. The scratching is characterized by haze and gloss values, measured transverse to the scratching direction, with a Micro HAZE plus (20° gloss and haze; Byk-Gardner GmbH, Geretsried, Germany). The measurement is effected before and after scratching. The differential values for gloss and haze before and after stress are reported as Δgloss and Δhaze.

### Assessment of Solvent Resistance

The solvent resistance of the coatings was typically tested with isopropanol, xylene, 1-methoxy-2-propyl acetate, ethyl acetate, acetone, in technical-grade quality. The solvents were applied to the coating with a soaked cotton bud and protected from vaporization by covering. Unless stated otherwise, a contact time of 60 minutes at about 23° C. was observed. After the end of the contact time, the cotton bud is removed and the test surface is wiped clean with a soft cloth. The inspection is immediately effected visually and after gentle scratching with a fingernail.

A distinction is made between the following levels:
0=unchanged; no change visible; cannot be damaged by scratching.
1=slight swelling visible, but cannot be damaged by scratching.
2=change clearly visible, can barely be damaged by scratching.
3=noticeable change, surface destroyed after firm fingernail pressure.
4=significant change, scratched through to the substrate after firm fingernail pressure.
5=destroyed; the coating is already destroyed when the chemical is wiped away; the test substance cannot be removed (has eaten into the surface).

Within this assessment, the test is typically passed with the ratings of 0 and 1. Ratings of >1 represent a “fail”.

### Assessment of Optical Properties

The transmission and the haze were determined to ASTM-D2457 with a BYK Haze Gard (from BYK, Germany). The gloss was measured to DIN 67530 with a BYK micro Tri Gloss (from BYK, Germany). The roughness values Ra, Rz were determined to DIN ISO 4287 with a Dektak 150 Profiler from Veeco Instruments (USA). For the determination of the further optical parameters of sparkle, DOI/MTF and Rs, the SMS 1000 (Sparkle Measurement System) from DM&S (Germany) was used.

### Example 1

### Production of the Inventive Coating Composition

In a 15 l tank, first of all, Degacryl MW 730 (copolymer based on PMMA, M_{w}=10⁶; Evonik) was dissolved in 1-methoxy-2-propanol at 100° C. (internal temperature) as follows: 4500 g of 1-methoxy-2-propanol were initially charged and 1100 g of Degacryl MW 730 were introduced while stirring. Thereafter, they were rinsed in with 2500 g of 1-methoxy-2-propanol. The dissolving operation takes about 4 hours. The result was a homogeneous, clear, colourless, viscous material. The mixture was cooled to room temperature after the dissolving operation. 1100 g of dipentaerythrityl penta-/hexaacrylate (DPHA, manufacturer. Cytec) were diluted separately with 2500 g of 1-methoxy-2-propanol. At room temperature, this solution was added to the apparatus and mixed in for 2 hours. 44.0 g of Irgacure 1000 (BASF), 22.0 g of Darocure 4265 (BASF) and 5.5 g of BYK 333 (manufacturer: BYK) were diluted separately with 400 g of l-methoxy-2-propanol. When this solution was homogeneous, it was added to the apparatus and mixed in thoroughly. The mixture was stirred with exclusion of light for about 6 hours. Yield: 11 363 g. The coating composition obtained in this way has a solids content of 17% and a viscosity (23° C.) of 9000 mPas. In the solids content of the coating composition, the proportion of the high polymer, and likewise the proportion of the reactive diluent, were each 48.4% by weight. The content of the ethylenically unsaturated groups per kg of solids content of the coating composition was about 5.2 mol.

### Example 2

### Coating of a Film

The coating composition obtained in Example 1 was applied to the structured side of a backing film, such as Makrofol DE 1-M or Makrofol DE 1-4 (Bayer MaterialScience AG, Leverkusen, Germany) by means of a slot coater.

Typical application conditions are as follows:
web speed 1.3 to 2.0 m/min
wet coating material applied 20-150 μm
air circulation dryer 90-110° C., preferably in the region of the TG of the polymer to be dried
residence time in the dryer 3.5-5 min.

The coating was effected roll to roll, meaning that the polycarbonate film was unrolled in the coating system. The films were conducted through one of the abovementioned application units and contacted with the coating solution. Thereafter, the films with the wet coating were run through the dryer.

After leaving the dryer, the now dried coating was typically subjected to UV curing, then provided with a lamination film, in order to protect it from soiling and scratching. Thereafter, the film was rolled up again. Said operations were effected continuously in a roll-to-roll coating system designed for that purpose.

### Example 3

### Coated Films Based on the Substrate Makrofol DE 1-M

Various Makrofol DE 1-M films of thickness 250 μm were coated with the coating composition from Example 1 in the process according to Example 2. Different film thicknesses of the coating were produced. In this way, the following film products were obtained (the respective layer thicknesses are stated in the brackets): B-3-1 (5 μm), B-3-2 (7 μm), B-3-3 (18 μm), B-3-4 (15 μm), B-3-5 (19 μm).

### Example 4

### Coated Films Based on the Substrate Makrofol DE 1-4

Various Makrofol DE 1-4 films of thickness 250 μm were coated with the coating composition from Example 1 in the process according to Example 2. Different film thicknesses of the coating were produced. In this way, the following film products were obtained (the respective layer thicknesses are stated in the brackets): B-4-1 (2 μm), B-4-2 (4 μm), B-4-3 (6 μm), B-4-4 (11 μm), B-4-5 (15 μm) B-4-6 (21 μm), B-4-7 (28 μm), B-4-8 (34 μm).

### Example 5

### Pencil Hardness, Steel Wool Scratching, Solvent Resistance

The coated films obtained in Examples 4 and 5 were tested with the above-specified test methods for pencil hardness, steel wool scratching and solvent resistance. The results are summarized in Table 1.

TABLE 1
Solvent resistance, pencil hardness and scratch resistance (B-3
are the coated films from Example 3; B-4 are the coated films from
Example 4; 1-1 substrate is a Makrofol DE 1-1 film (Bayer) which
has two smooth sides and serves as a comparative example).

| | | | Steel wool |
|---|---|---|---|
| | | Pencil | (manufacturer: |
| | Solvent | hardness | Rakso, No. 00) |
| | IP/MPA/X/EA/Ac | 500 g | 560 g/10 DM |
| Films examined | 1 h/RT | Mitsubishi | ΔG/ΔH |
| 1-4 substrate (PC) | 0/5/5/5/5 | 4B | — |
| B-4-1 2 μm | 0/0/0/0/0 | H | 2/10 |
| B-4-2 4 μm | 0/0/0/0/0 | H | 2/11 |
| B-4-3 6 μm | 0/0/0/0/0 | H | 1/7 |
| B-4-4 11 μm | 0/0/0/0/0 | H | 2/9 |
| B-4-5 15 μm | 0/0/0/0/0 | H | 2/14 |
| 1-M substrate (PC) | 0/5/5/5/5 | 3B | — |
| B-3-1 5 μm | 0/0/0/0/0 | H | 1/4 |
| B-3-2 7 μm | 0/0/0/0/0 | H | 2/15 |
| 1-1 substrate (PC) | 0/5/5/5/5 | 3B | 100/285 |

Table 1 shows that the inventive coating, in all the thicknesses selected, even in a thin layer starting from 2 μm, assures good coverage of the structured polycarbonate surface. All the coated samples are solvent-resistant. In comparison, uncoated polycarbonate is very sensitive to 1-methoxy-2-propyl acetate, xylene, ethyl acetate and acetone.

The same applies to scratch resistance in the steel wool test. Here too, it can clearly be seen that the coating for all samples assures protection of the polycarbonate surface irrespective of the thickness of the coating material. The pencil hardness of the coated surfaces rises by 4-5 units compared to the uncoated film.

### Example 6

### Optical Properties

The coated films B-3 and B-4 obtained in Examples 3 and 4, having commercially available anti-glare films, were assessed in terms of optical properties. This involved determining the transmission (perpendicular incidence of light), haze, gloss and roughness by the processes specified above. For this comparison, 2 different AG films from MSK (Japan) were examined. Thus, these commercial AG films exhibit haze values between 6 and 11%; other firms specify desirable haze values up to 40% (e.g. J Touch). In addition, because of the required function of anti-glare effect, the gloss value established should not be too high (GU<100). For all the samples, the transmission values exceed 90%. Moreover, the optical parameters of sparkle, DOI/MTF (pixel pattern width and height each of 244.5 μm) and reflection Rs are in good agreement compared with the commercial products.

TABLE 2.1
Summary of the optical measurements

| | Transmission | Haze | Gloss 60° | Ra | Rz |
|---|---|---|---|---|---|
| Sample | [%] | [%] | [GU] | [nm] | [nm] |
| GL 110 (MSK) *) | 90.88 | 6 | 83.1 | 194 | 744 |
| GL 130 (MSK) *) | 90.87 | 10.2 | 60.4 | 374 | 1620 |
| AG film: CARU | 89.4 | 12.0 | 73.0 | | |
| Clearguard **) | | | | | |
| 1-M substrate | 90.9 | 76.6 | 4.0 | 180-230 | 800-1300 |
| B-3-1 5 μm | 92.1 | 10.9 | 44.7 | 208 | 885 |
| B-3-2 7 μm | 92.2 | 7.4 | 67.2 | 183 | 642 |
| B-3-3 18 μm | 92 | 5.7 | 87.7 | 82 | 196 |
| B-3-4 15 μm | 92 | 6.3 | 84.7 | 103 | 268 |
| B-3-5 19 μm | 91.9 | 5.6 | 88.2 | 61 | 209 |
| 1-4 substrate | 90 | 82.7 | 3.2 | 650-720 | 2800-3500 |
| B-4-2 4 μm | 91.9 | 35.3 | 18.5 | 325 | 1325 |
| B-4-3 6 μm | 92.2 | 24.2 | 24.8 | 387 | 1544 |
| B-4-4 11 μm | 92.3 | 14.5 | 38.2 | 299 | 988 |
| B-4-5 15 μm | 92.3 | 7.7 | 58.5 | 275 | 682 |
| B-4-6 21 μm | 92.2 | 5.9 | 76.5 | 264 | 521 |
| B-4-7 28 μm | 92.3 | 4.2 | 85.3 | 260 | 467 |
| B-4-8 34 μm | 92.4 | 4.6 | 88.3 | 244 | 502 |

TABLE 2.2
Summary of the optical measurements (continuation of Table 2.1)

| | | | | Coating |
|---|---|---|---|---|
| | Sparkle | DOI/MTF | | material |
| | [@ | [% @ | Rs | thickness |
| Sample | 245 μm] | 245 μm] | [% @ 45°] | [μm] |
| GL 110 (MSK) *) | 0.035 | 97.07 | 0.561 | |
| GL 130 (MSK) *) | 0.033 | 95.33 | 0.257 | |
| AG film: CARU | | | | |
| Clearguard **) | | | | |
| 1-M substrate | | | | |
| B-3-1 5 μm | | | | 5 |
| B-3-2 7 μm | 0.031 | 97.61 | 0.800 | 7 |
| B-3-3 18 μm | 0.025 | 97.94 | 1.713 | 18 |
| B-3-4 15 μm | | | | 15 |
| B-3-5 19 μm | | | | 19 |
| 1-4 substrate | 0.029 | 44.20 | 0.053 | |
| B-4-2 4 μm | 0.055 | 99.35 | 0.188 | 4 |
| B-4-3 6 μm | 0.043 | 99.35 | 0.234 | 6 |
| B-4-4 11 μm | 0.039 | 99.02 | 0.345 | 11 |
| B-4-5 15 μm | 0.035 | 98.65 | 0.551 | 15 |
| B-4-6 21 μm | 0.040 | 99.02 | 0.775 | 21 |
| B-4-7 28 μm | 0.040 | 98.70 | 0.985 | 28 |
| B-4-8 34 μm | | | | 34 |

*) Commercial products from Meihan Shinku Kogyo Co. Ltd., Japan
**) Trade names

In tables 2.1 and 2.2: Ra is the arithmetic mean of the absolute values of the profile deviations within the reference distance. Rz is the arithmetic mean of the greatest individual roughnesses from a plurality of adjacent individual measurement distances. Sparkle is defined as the ratio of the variance (σ) and the mean (μ) of the grey value distribution measured for a given pixel pattern (defined by the SMS 1000 instrument: sub-pixel width (57.4 μm)+gap width (187.1 μm)=244.5 μm). DOI/MTF is the ratio of the optical contrast of the object (here: image without anti-glare film) and the image (here: image with anti-glare film). The pixel pattern is defined as 244.5 μm by the SMS 1000 instrument. Rs is the percentage of regular light reflection at an angle of light incidence of 45°.

The samples B-3-X have been applied to a 1-M substrate, whereas the B-4-X samples have been applied to a 1-4 substrate.

For commercial anti-glare films, the Rz values exceed 600 nm. In addition, a gloss value below GU 85 is desirable. Typically, DOI/MTF values ≧95% are found.

Films having Rz values >600 nm are attained on 1-M substrate at coating material thicknesses of <10 μm, and in that case show gloss values GU<70 and DOI/MTF values >96%. On 1-4 films, Rz values >600 nm are achieved for coating material thicknesses below a value between 15 and 21 μm. Here, the gloss values GU are <70, and the corresponding DOI/MTF values >98%.

As apparent from Table 2, the inventive coated films have excellent anti-glare properties. It has thus been shown that the coated films according to the present invention have anti-glare properties, combined with simultaneous scratch resistance and resistance to many other solvents such as, more particularly, acetone, which is the most aggressive organic solvent towards polycarbonate. Thus, the inventive films are of excellent suitability for application in many fields of industry, especially in those in which a transparent, anti-glare surface having high mechanical and chemical durability is required. More particularly, the inventive coated films are suitable for use as a front pane of displays of computer screens, televisions, display systems and mobile phones.

1.-15. (canceled)

16. A coating composition comprising
(a) at least one thermoplastic polymer in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent;
wherein the solids content of the coating composition is in the range from ≧0 to ≦40% by weight, based on the total weight of the coating composition.

17. The coating composition as claimed in claim 16, wherein the proportion of ethylenically unsaturated groups is at least 3 mol per kg of the solids content of the coating composition.

18. The coating composition as claimed in claim 16, wherein the solvent (d) comprises 1-methoxy-2-propanol.

19. The coating composition as claimed in claim 16, wherein the (a) thermoplastic polymer has a Vicat softening temperature VET to ISO 306 of at least 90° C.

20. The coating composition as claimed in claim 16, wherein the thermoplastic polymer comprises PMMA homopolymers and copolymers of 70% by weight to 99.5% by weight of methyl methacrylate and 0.5% by weight to 30% by weight of methyl acrylate.

21. A coated polymer film comprising a polymer film having an anti-glare surface and a coating on this surface, said coating being obtained by coating with a coating composition as claimed in claim 16, said coating having a layer thickness in the range of ≧2 μm and ≦20 μm.

22. The coated polymer film as claimed in claim 21, wherein the polymer film comprises a polycarbonate film.

23. The coated polymer film as claimed in claim 21, wherein the at least one anti-glare surface of the polymer film in the uncoated state is characterized by a roughness depth Rz to DIN EN ISO 4287 in the range of ≧800 and ≦3600 nm.

24. The coated polymer film as claimed in claim 21, wherein the gloss value GU of the at least one coated surface to ASTM-D2457 at 60° is ≦80.

25. The coated polymer film as claimed in claim 21, wherein the surface of the coating has a roughness Rz to DIN EN ISO 4287 of at least 600 nm.

26. A process for producing a coated film, comprising the steps of:
(i) providing a film having at least one anti-glare surface of the film;
(ii) coating the film on the side of the anti-glare surface with a coating composition comprising
(a) at least one thermoplastic polymer in a content of at least 30% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent; where the coating has a layer thickness in the range of ≧2 μm and ≦20 μm and the solids content of the coating composition is in the range from ≧0 to ≦40% by weight, based on the total weight of the coating composition;
(iii) Drying the coating;
(iv) optionally cutting the film to size delaminating, printing and/or thermally or mechanically forming the film; and
(v) irradiating the coating with actinic radiation to cure the coating.

27. A product comprising at least one coated polymer film as claimed in claim 21, said product being selected from the group consisting of architectural glazing elements, covering panes, front panes for displays, and non-shiny plastics parts for electrics, electronics and motor vehicle interior trim.

28. The product as claimed in claim 27, wherein the display is a display of computer screens, televisions, display systems and mobile phones, and the non-shiny plastics part is an electronics housing component or interior trim component of automobiles, rail vehicles, water vehicles or aircraft.

29. A method comprising utilizing the coated polymer film as claimed in claim 21 as a high-transparency anti-glare front pane for displays, or a non-shiny plastics part for electrics, electronics and motor vehicle interior trim.

30. The method of claim 29, wherein the display is a display of computer screens, televisions, display systems and mobile phones, and the non-shiny plastics part is an electronics housing component or interior trim component of automobiles, rail vehicles, water vehicles or aircraft.
